(19) United States
(12) Patent Application Publication
(10) Pub. No.: US 2010/0137126 A1
(43) Pub. Date: Jun. 3, 2010

(54) MIXED PRODUCT

(75) Inventor: Franz Josef Philipp, Hasselroth (DE)

Correspondence Address: MOTS LAW, PLLC, 1629 K STREET N.W., SUITE 602, WASHINGTON, DC, 20006-1635, US

(73) Assignee: First Vandalia Luxemborug Holding S.A. Fiduciaire Continentate, S.A., Luxembourg (LU)

(21) Appl. No.: 12/526,253

(22) PCT Filed: Feb. 7, 2008
(86) PCT No.: PCT/EP08/00960

§ 371 Date: Jan. 21, 2010

(30) Foreign Application Priority Data
Feb. 7, 2007 (DE) 10 2007 006 137.6

(51) Int. Cl. B01J 20/22; B01J 29/04; B01J 20/26

(52) U.S. Cl. 502/62; 502/401; 502/402

(57) ABSTRACT

The invention teaches a mixed product of organic and inorganic particulate materials in a substantially homogeneous matrix. The invention has organic and inorganic particulate materials form an essentially homogeneous matrix, wherein with respect to the dry weight 75 to 85 weight %, preferably about 82 weight % of the basic material are substantially free of metallic material and that the remainder is additive materials (additives), and wherein 80 to 90 weight %, with respect to the dry total quantity of additive materials, comprise clay, inclusive of bentonite, zeolite and lime, and whereby the remainder is lignin and/or lignin derivatives, and that the particle size is appropriate to the matrix developing material between 50 μm and for 3 mm.

The invention concerns a mixed product of organic and inorganic particulate materials and/or material mixtures with an auxiliary material used (or auxiliary mixture) therein. The auxiliary material (or auxiliary mixture) is an additive which lends different properties to a final product. The properties of the product are calculable and adjustable thereby before commencement of manufacture. Depending upon starting material and the desired properties of the final product the auxiliary material is added. The auxiliary material leads to the formation of crystal structures and fulfils (depending upon the final product) different functions:
energy carrier/material for energy conversion and/or
pore inducing means and/or
structuring means and/or
reducing agent and/or
filtering material

Certain mixed products can be used as energy stores, whereby the energy store quantity is adjustable. Further other ones of the mixed products can be used as reducing agents in different applications. Depending upon the mixed product, a use can, for example, be for the treatment of drinking water, for metal finishing or during wood processing and paper processing. All of the end products manufactured from the mixed product can be optimised with respect to target properties. For example, paper and cardboard that have been treated with this mixed product exhibit hitherto unknown stability and stiffness. The improved paper or the improved cardboard is similar to a reinforced plastic tube in one aspect of the present invention with respect to these properties.

Such mixed products are known e.g. from WO 1996/06060 A. This document describes a palletized product manufactured from sludge and a silica-like, pourable bonding agent with fine minerals, aerated concrete or saw mill residue by applying several compression steps, with intermediate decompression. The palletized product can be used in agriculture or placed in rubbish tips safely.

From DE 101 60 163 A, a product is known for use in a cement clinker rotating furnace to make a product from sludge and fly ashes and thus save lime.

It is known from DE 198 48 432 A to transform a product of sewage sludge and sewage sludge residuals or tar oil or similar products by pressing into a state which permits the thermal use of the product for fixed bed high-pressure gasification.

An object of the invention relates to the creation of a material composed of an organic and inorganic particulate material and/or material mixtures with a high specific internal surface; i.e. a high adsorptive capacity for as many polluting materials as possible, for example oil, exhaust gases and harmful particles, for e.g. exhaust particles and physicochemical properties for the immobilization of environmentally harmful materials, for example toxic materials. The desired materials should be easily manufactured from economical raw materials in a conventional way.

This problem is solved according to the invention by organic and inorganic particulate materials and/or material mixtures forming together a substantially homogeneous matrix. 75 to 85 weight %, preferably around 82 weight % of the dry weight of the starting material is a residue. The residue is substantially free from metallic material. The problem is further solved in that the residues are additives of 80 to 90 weight % with respect to the dry total quantity of additives. The additives are made of clay, inclusive of bentonite, zeolite and lime, whereby the remainder is lignin and/or lignin derivatives. The particle size of the material and/or material mixtures forming the substantially homogeneous matrix is between 50 μm and 3 mm.

A “homogeneous matrix” in the description and the claims is to be understood as a structure that when microscopically seen provides the mixed product in different places with the same properties. The carrier materials and the embedded materials therein are still distinguishable when microscopically seen. These properties result from the crystal structure created by means of the mixture.

The invention is based on the recognition that mixed products having kalzit (CaCO₃), rutile (TiO₂) and ankerit (CaMgO.77FeO.23(CO₃)₂) of small size in the weight ratio (70% to 95%):(2 to 15):(2 to 15), allow the formation of a matrix with the desired properties. It is not necessary that these three components are present to a large extent within the mixed product. Rather to the contrary, it is sufficient that they provide 3% to 5%. If necessary in individual cases 8 to 10 weight % of the listed additives are present. Rutile and ankerit do not have to be evenly distributed.

The associated relative mass ratios of the components of the additive materials are: oxygen 50-55 magnesium 1.0-1.5, calcium 32-38, titanium 1-2 and iron 0.7-1.5. This is achieved by taking into account the composition and the quantity of the other materials, including those elements which do not promote the formation of the matrix materials.

These values do not require exact observance as compared to chemical reactions, having firm stoichiometry, since a surplus of components can stay simply as a kind of “filler” or can escape accordingly from the matrix. The filler deposits itself in the matrix, which otherwise would be a homogeneous matrix.

The invention is described in more detail, by means of the following figures:

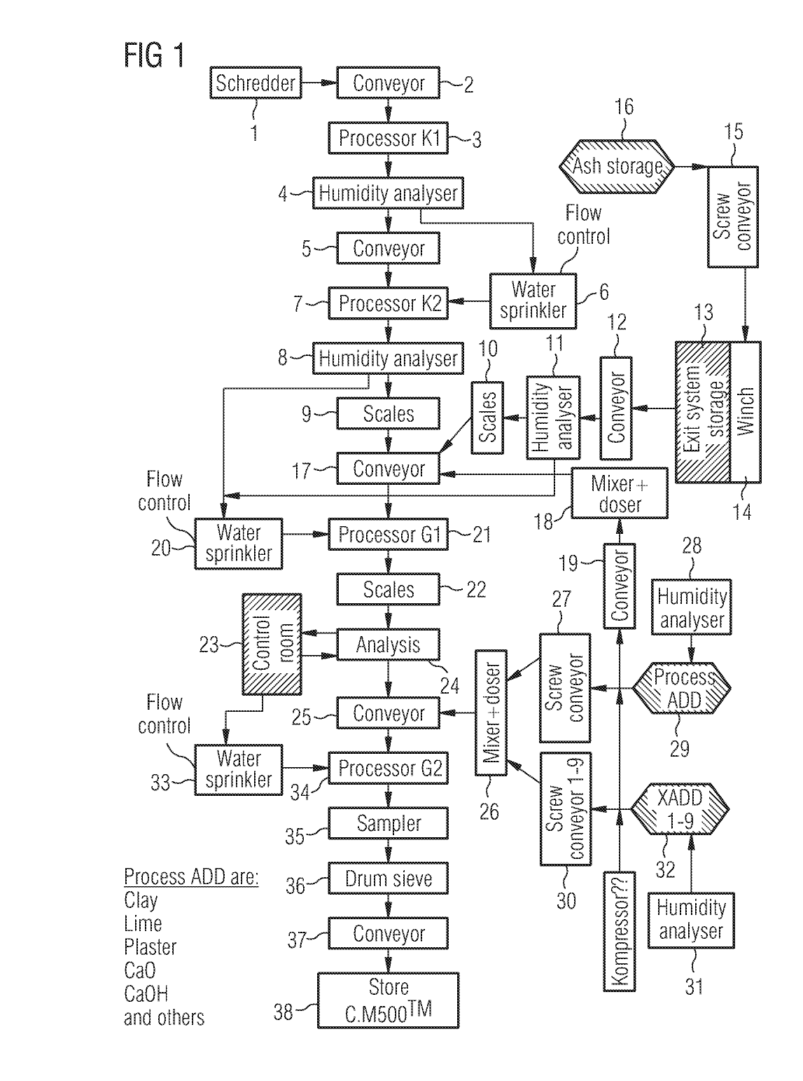

FIG. 1 shows an overview of the manufacturing facility.

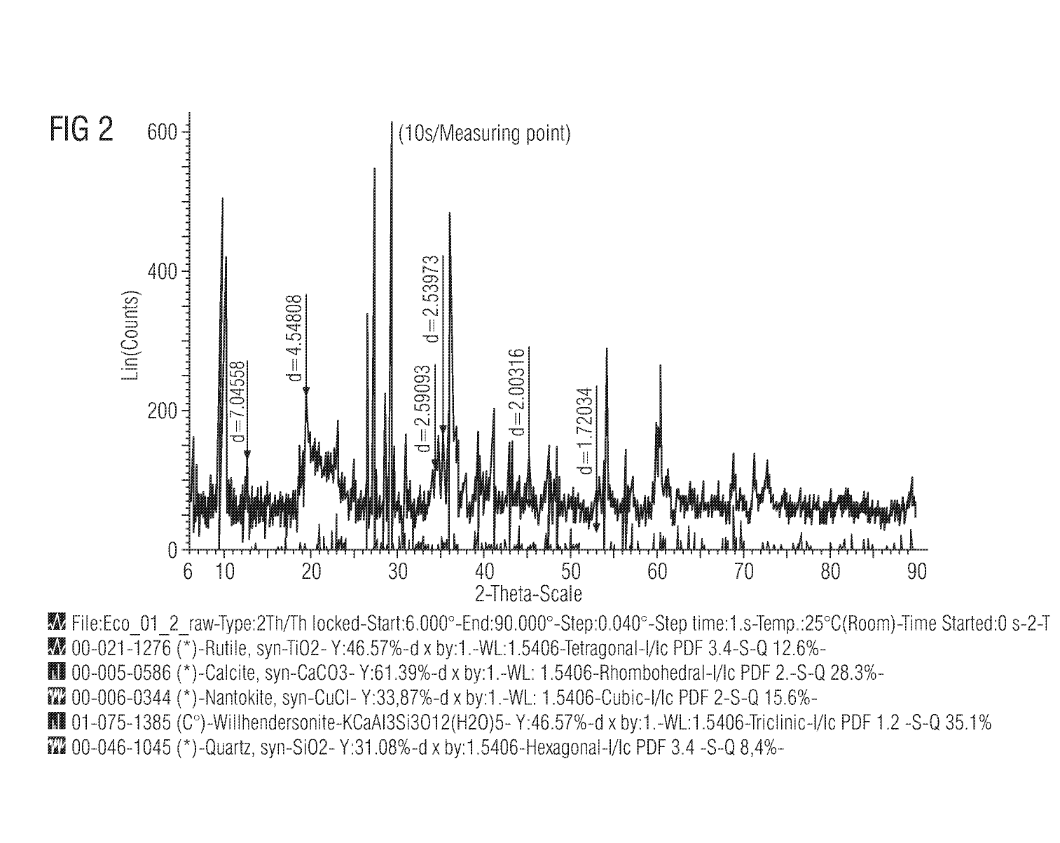

FIG. 2 shows a powder diffractogram of a first mixed starting material.

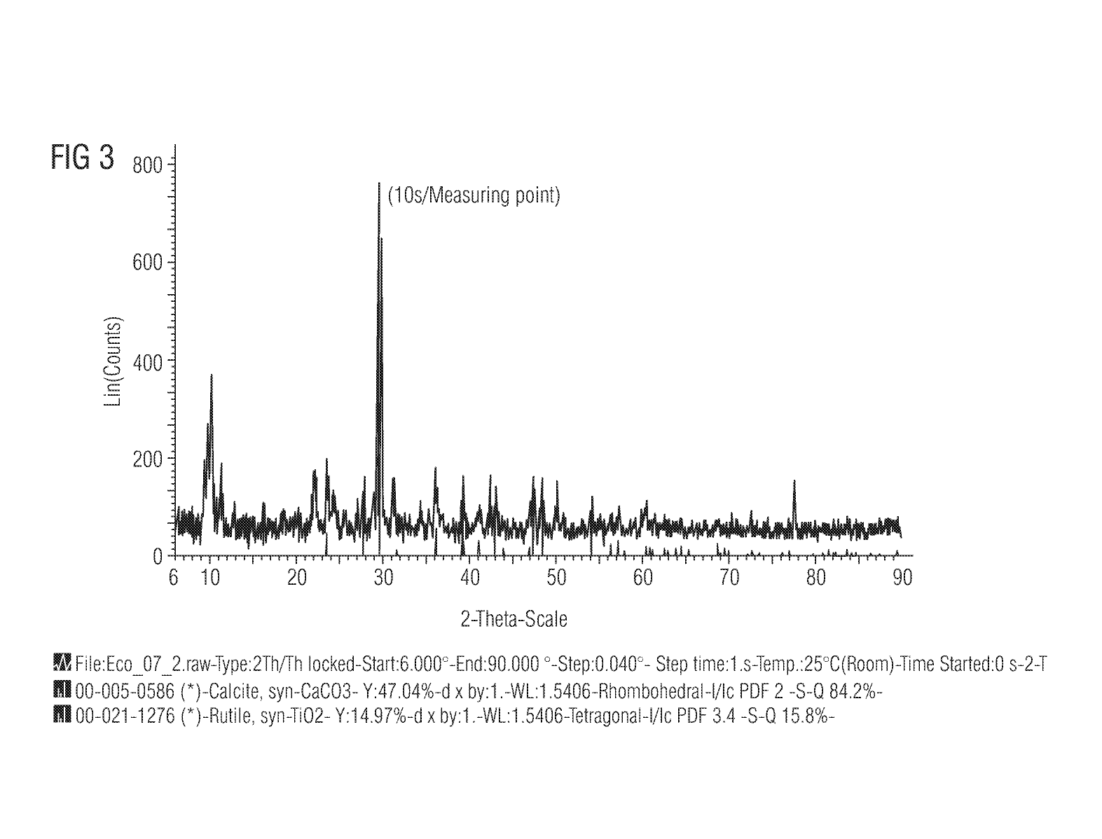

FIG. 3 shows a powder diffractogram of a first mixed product according to invention, which is obtained from the first mixed starting material

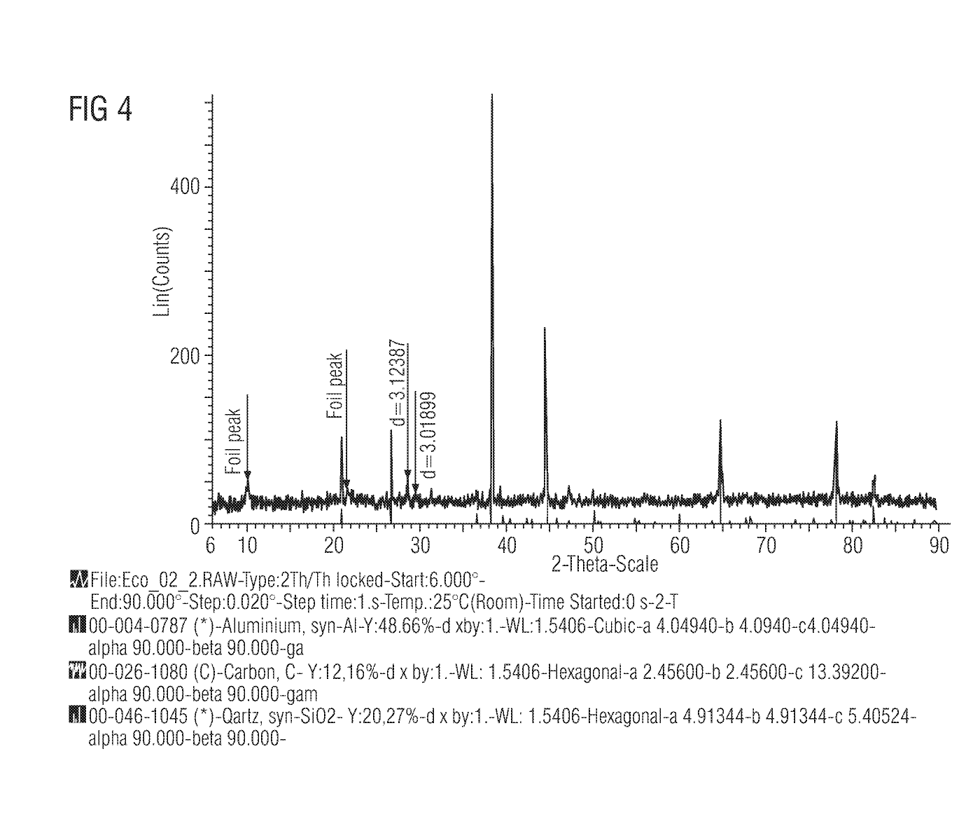

FIG. 4 shows a powder diffractogram of a second mixed starting material.

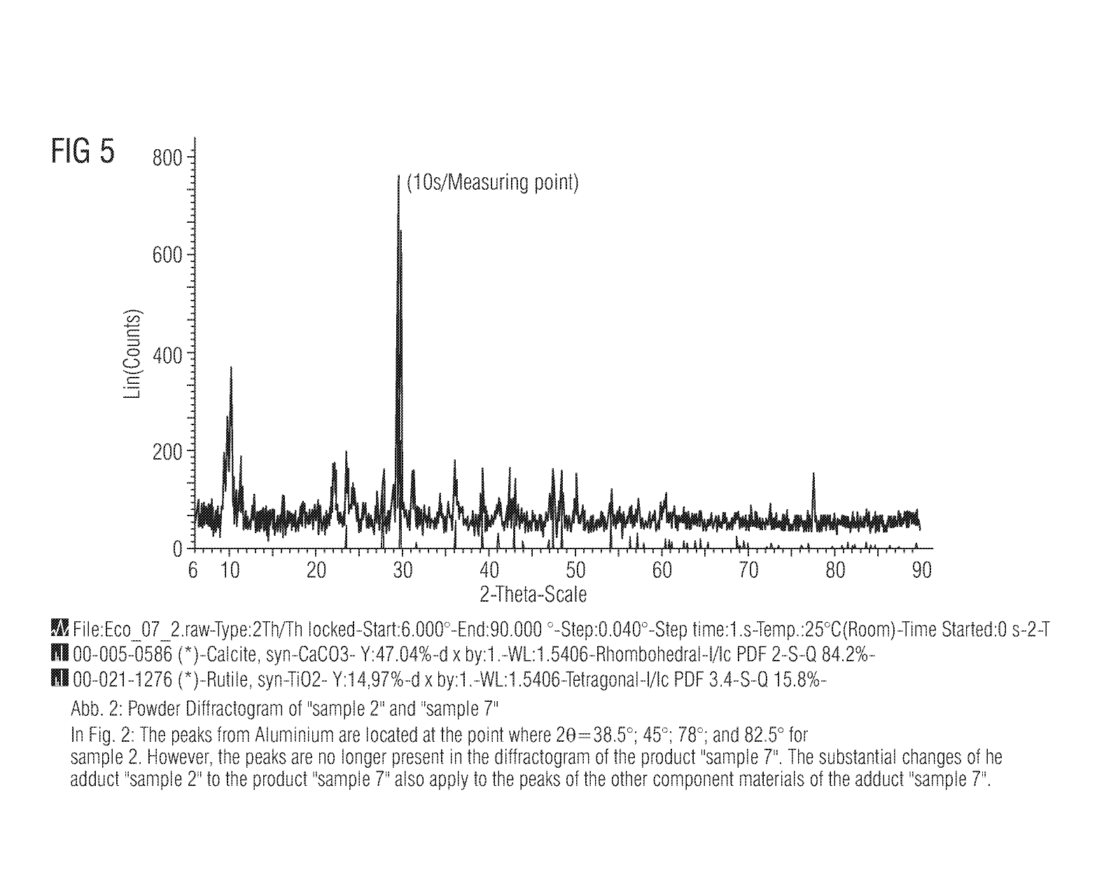

FIG. 5 shows a powder diffractogram of a second mixed product according to invention, which is obtained from the second mixed starting material.

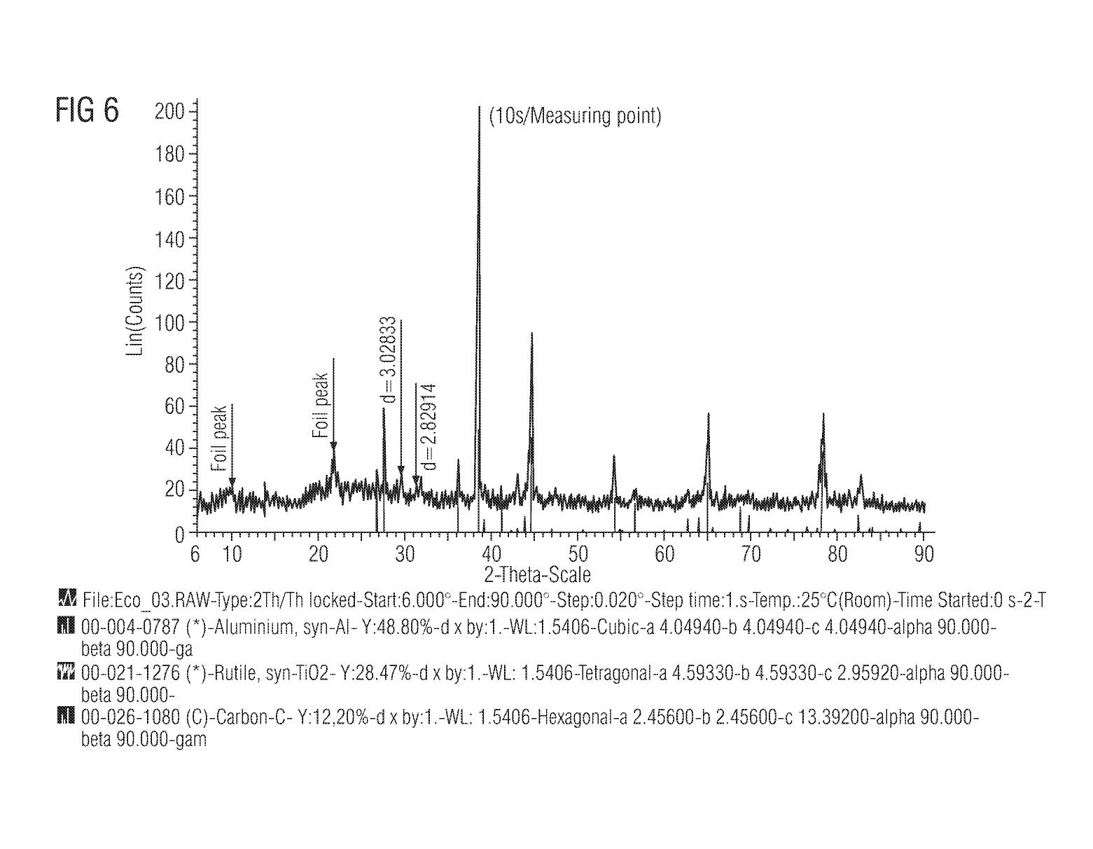

FIG. 6 shows a powder diffractogram of a third mixed starting material.

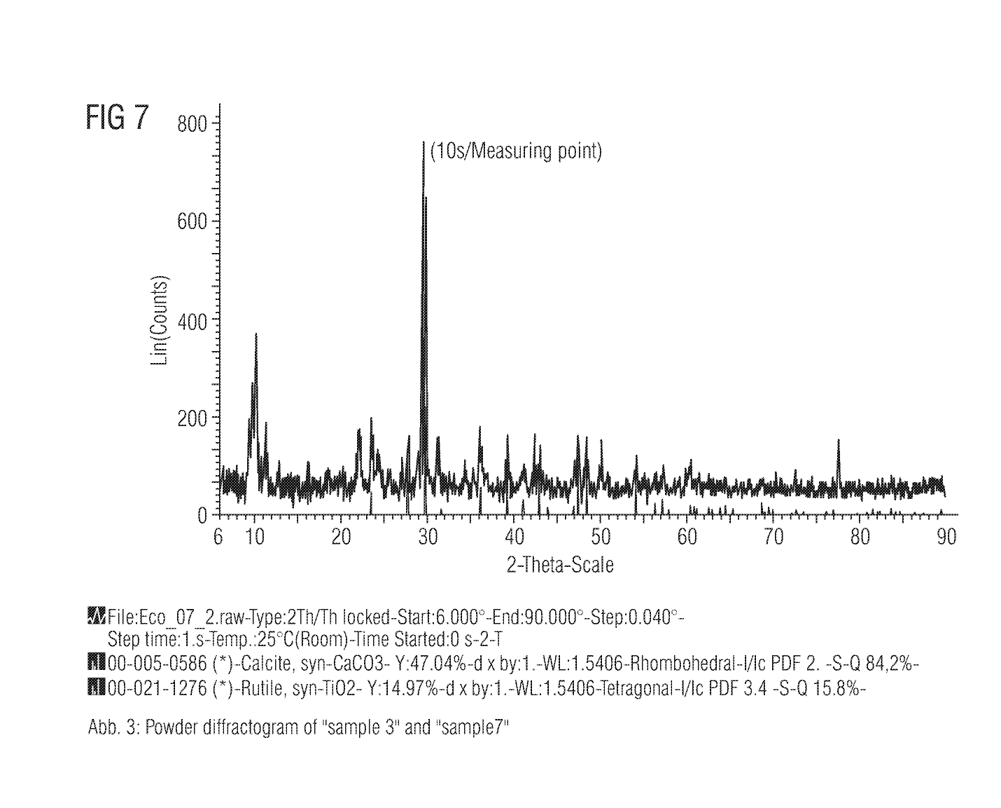

FIG. 7 shows a powder diffractogram of a third mixed product according to invention, which is obtained from the third mixed starting material

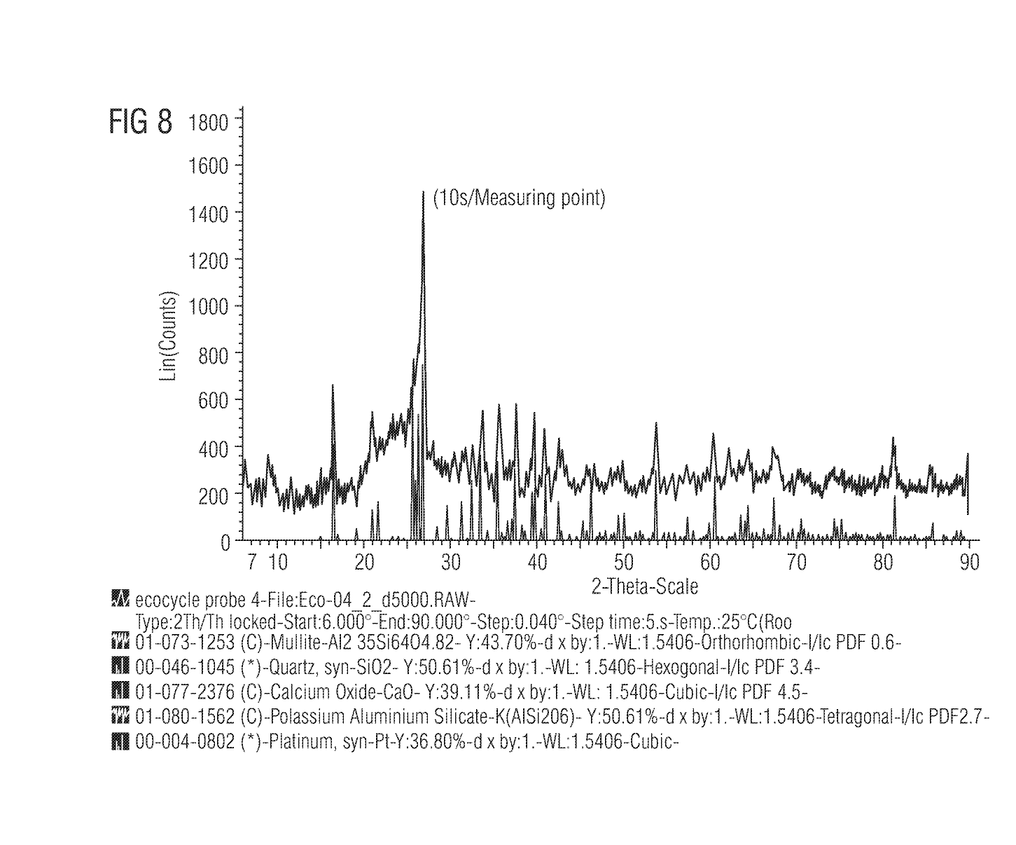

FIG. 8 shows a powder diffractogram of a fourth mixed starting material

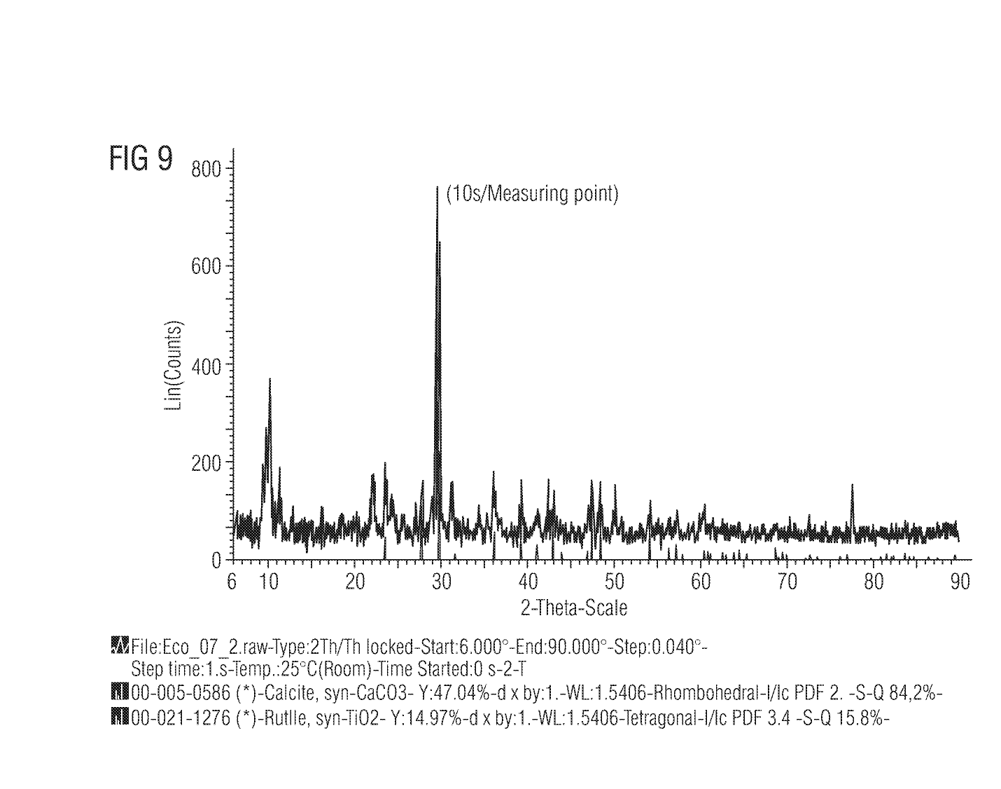

FIG. 9 shows a powder diffractogram of a fourth mixed product according to invention, which is obtained from the fourth mixed starting material

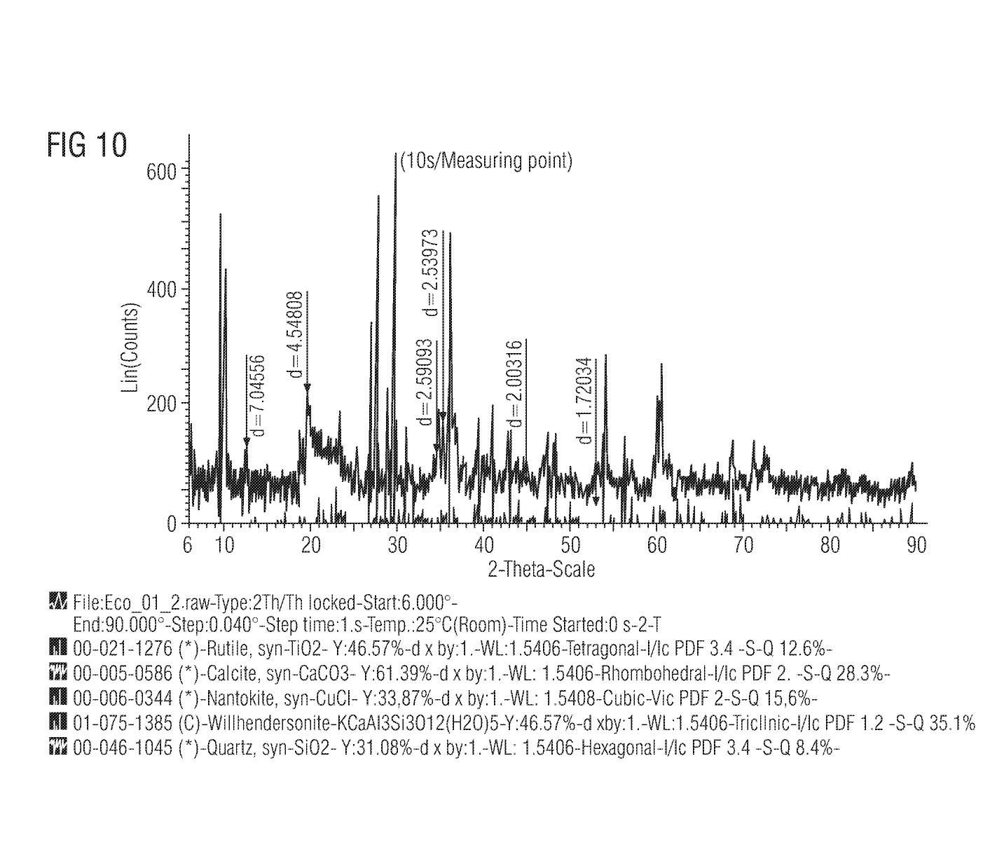

FIG. 10 shows a powder diffractogram of a fifth mixed starting material

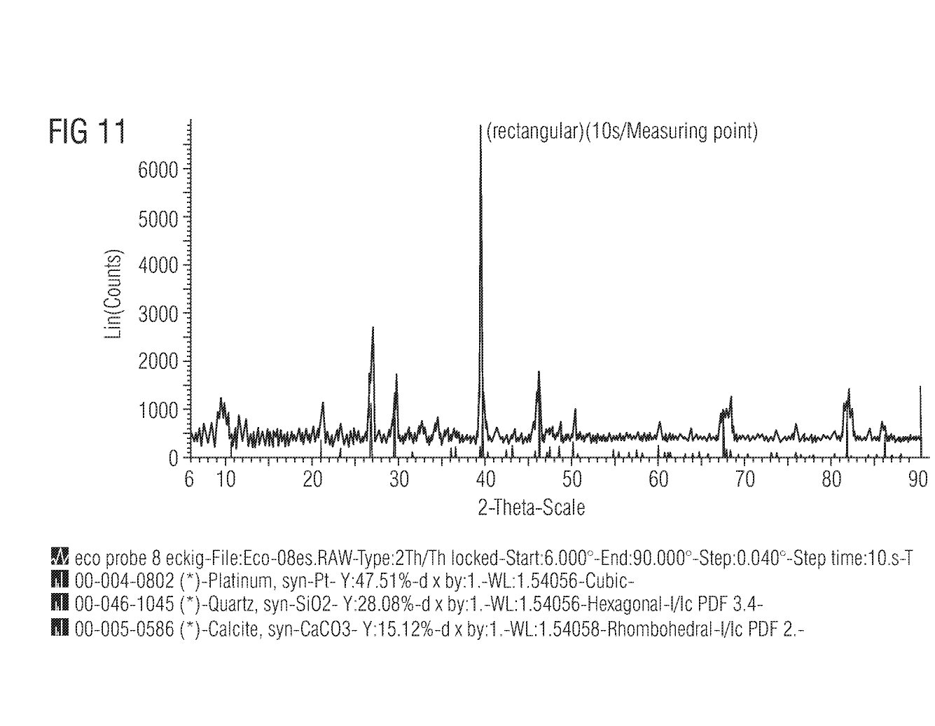

FIG. 11 shows a powder diffractogram of a fifth mixed product according to invention, which is obtained from the fifth mixed starting material

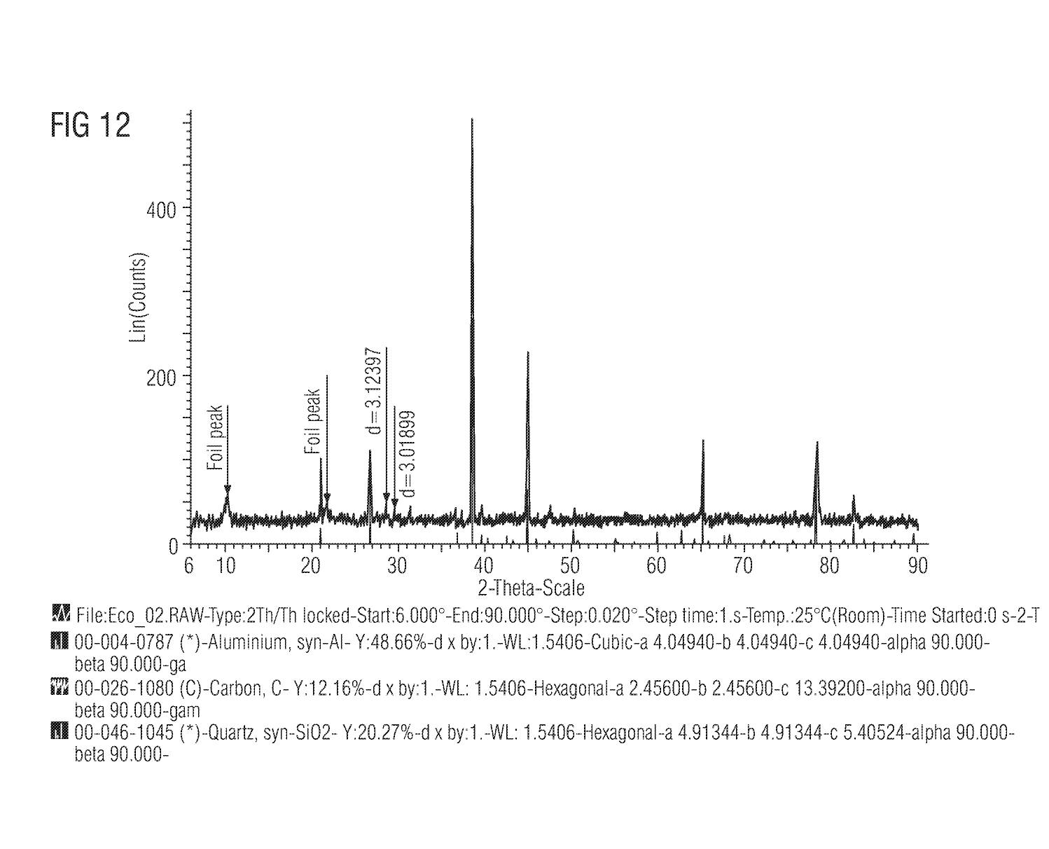

FIG. 12 shows a powder diffractogram of a sixth mixed starting material

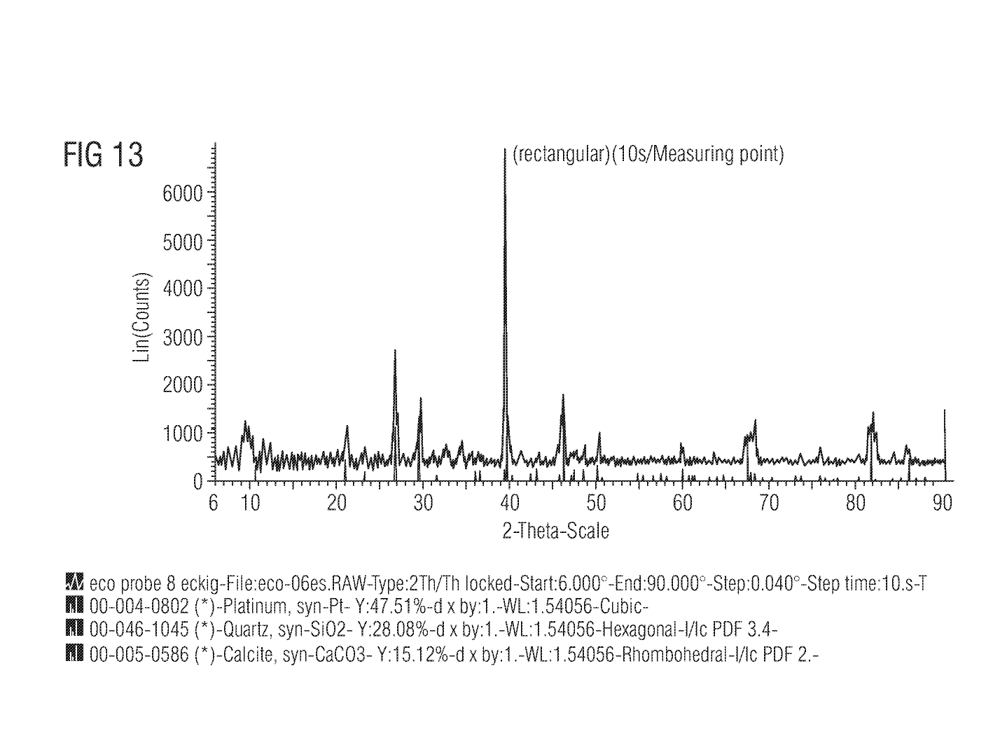

FIG. 13 shows a powder diffractogram of a sixth mixed product according to invention, which is obtained from the sixth mixed starting material

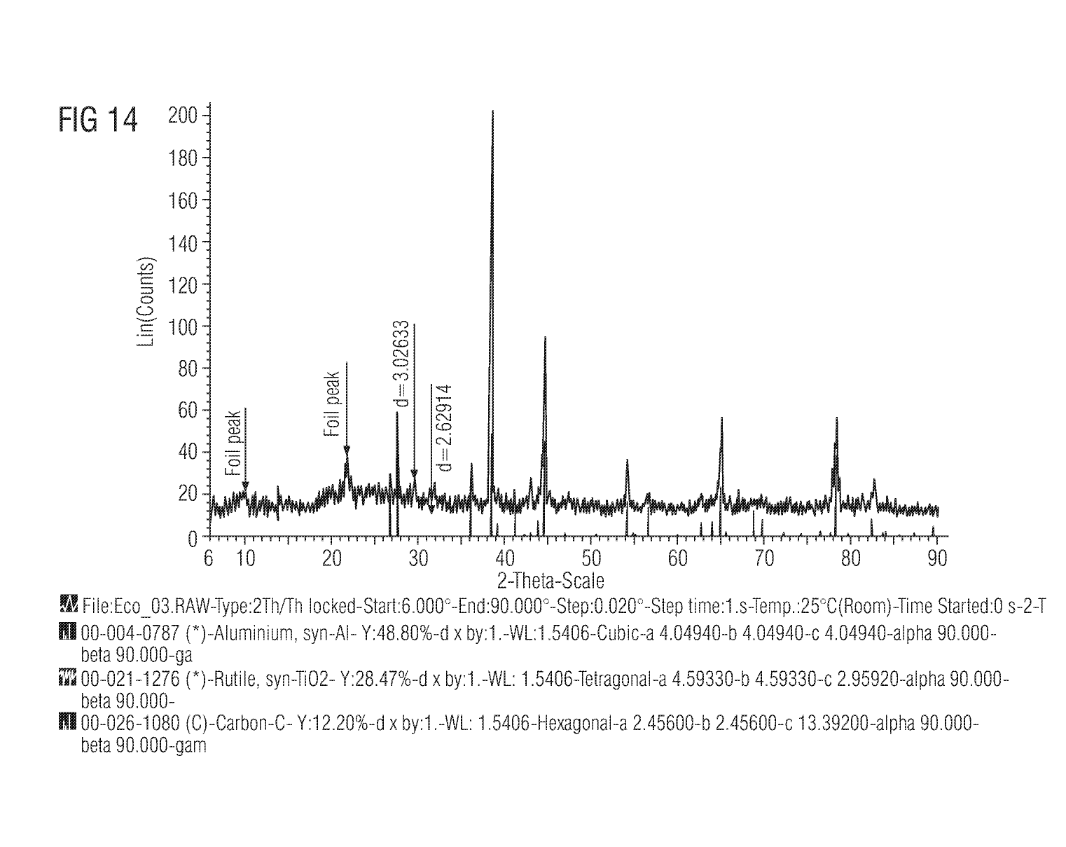

FIG. 14 shows a powder diffractogram of a sieved mixed starting material

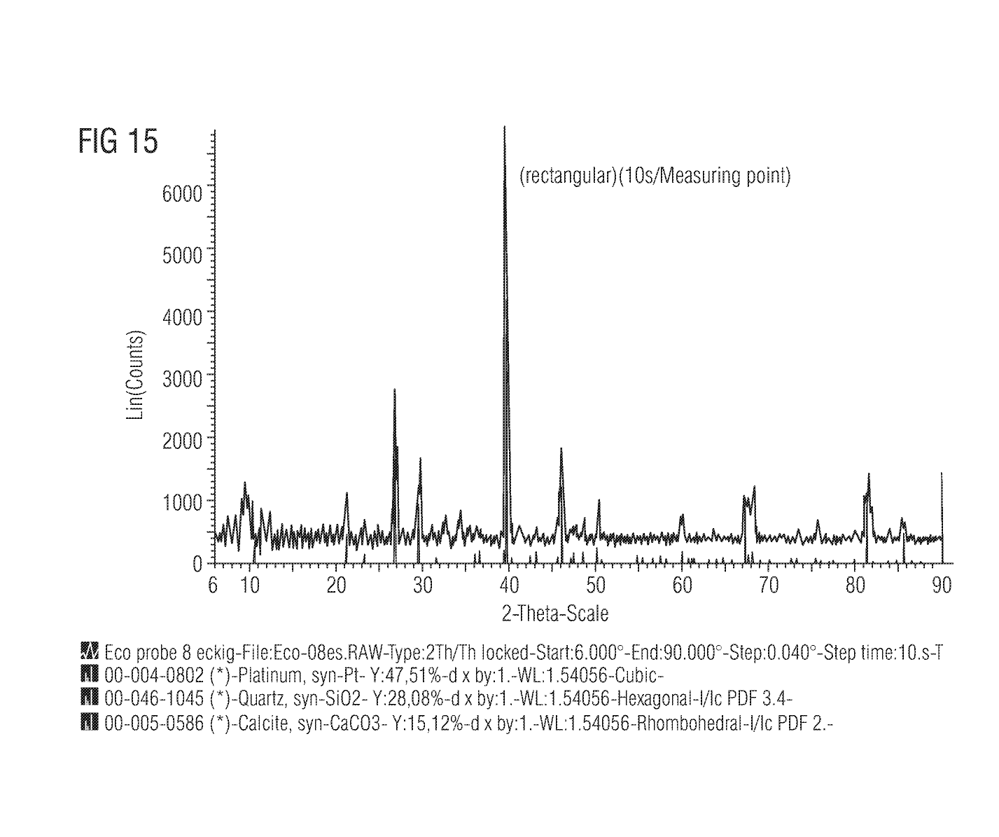

FIG. 15 shows a powder diffractogram of a sieved mixed product according to invention, which is obtained from the sieved mixed starting material

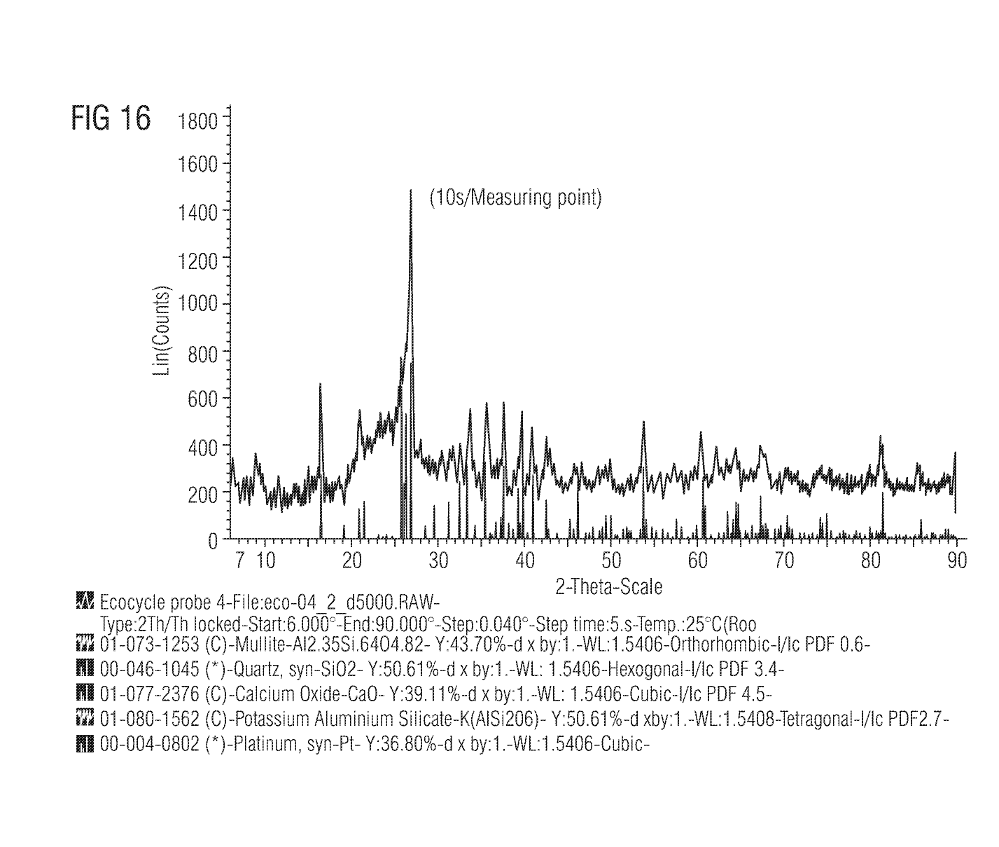

FIG. 16 shows a powder diffractogram of a respected mixed starting material

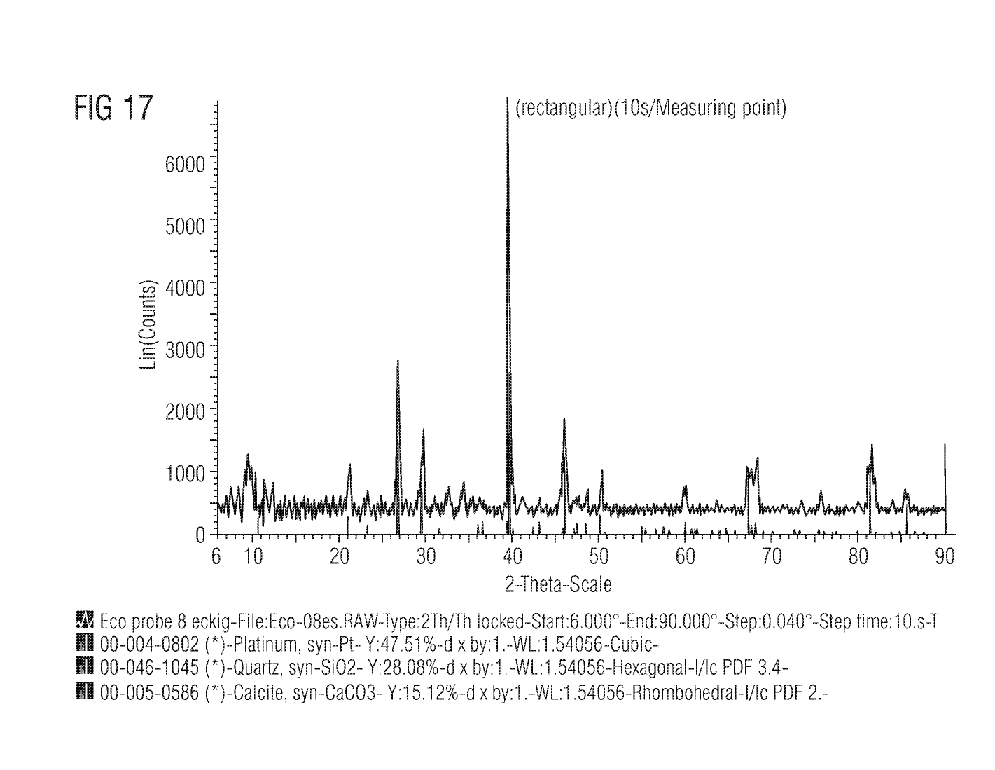

FIG. 17 shows a powder diffractogram of a respected mixed product according to invention, which is obtained from the respected mixed starting material.

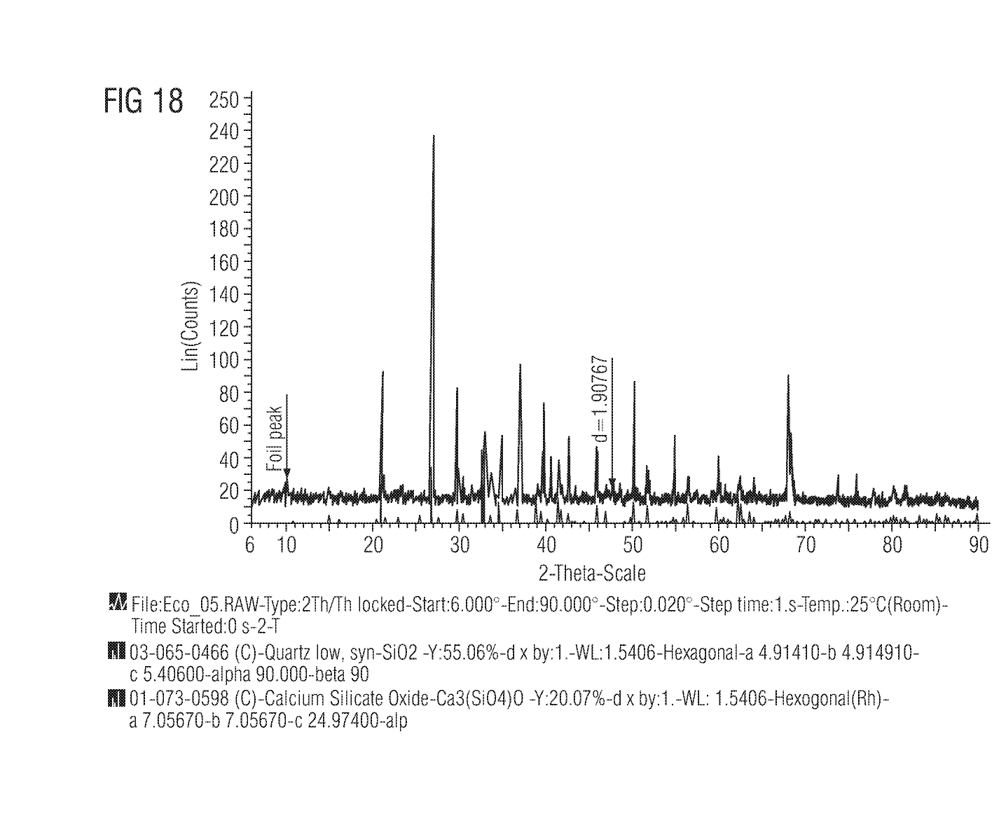

FIG. 18 shows a powder diffractogram of a ninth mixed starting material.

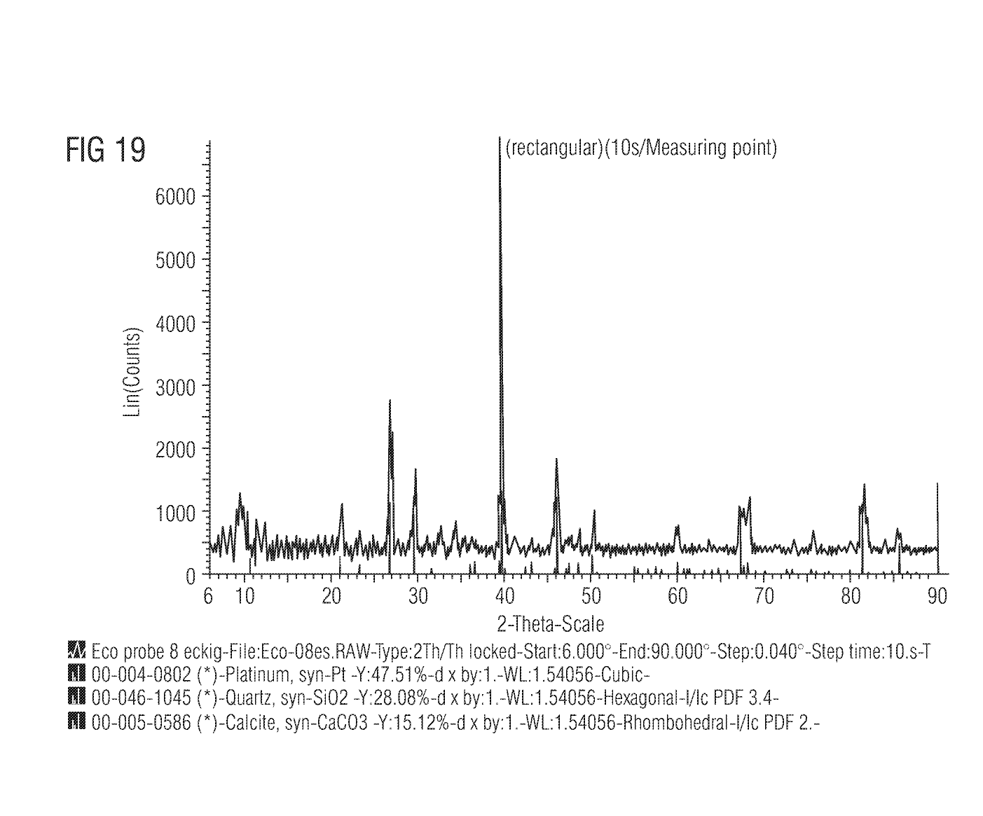

FIG. 19 shows a powder diffractogram of a ninth mixed product according to invention, which is obtained from the ninth mixed starting material.

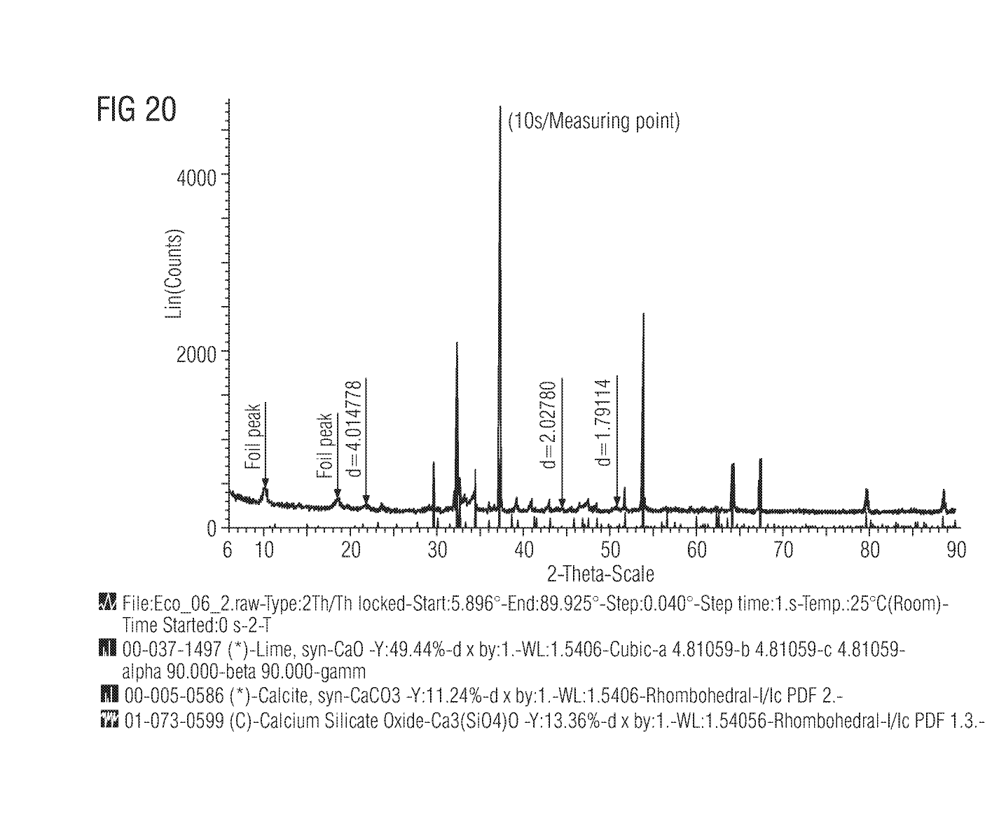

FIG. 20 shows a powder diffractogram of a tenth mixed starting material.

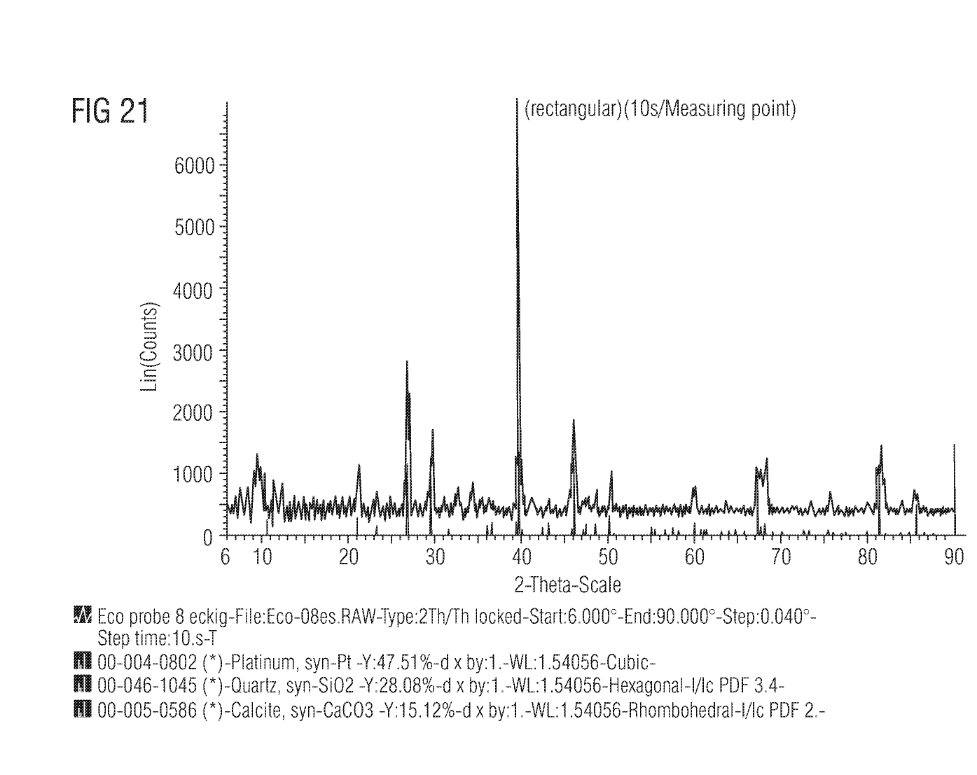

FIG. 21 shows a powder diffractogram of a tenth mixed product according to invention, which is obtained from the tenth mixed starting material.

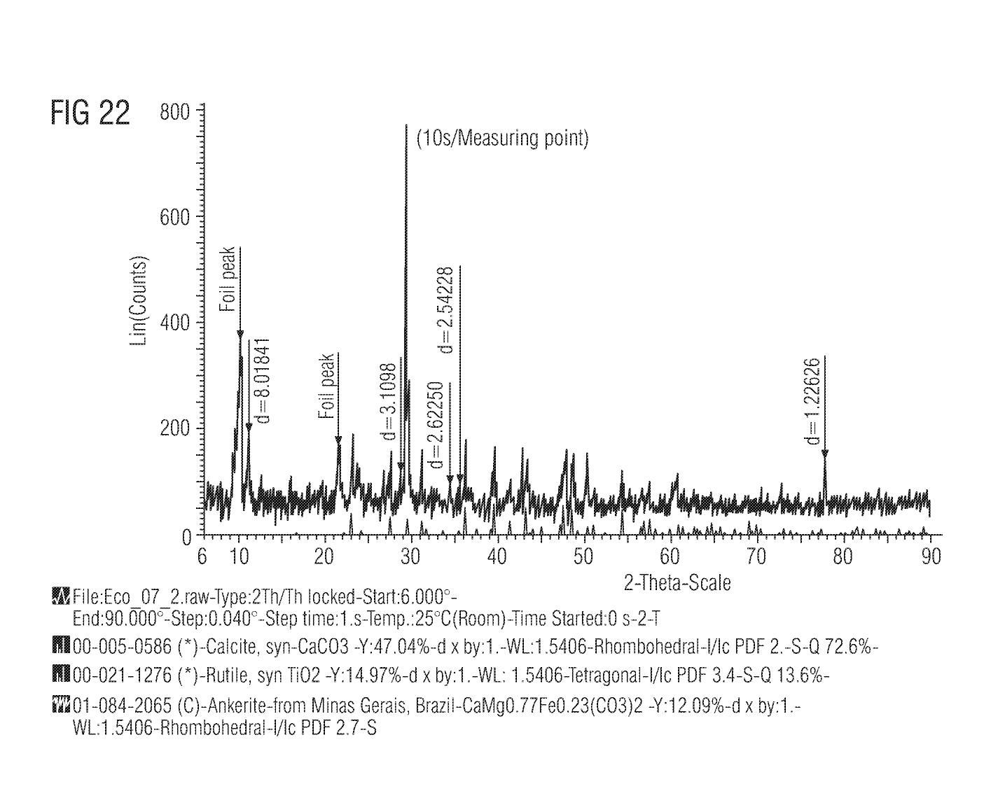

FIG. 22 shows a powder diffractogram of a eleventh mixed starting material.

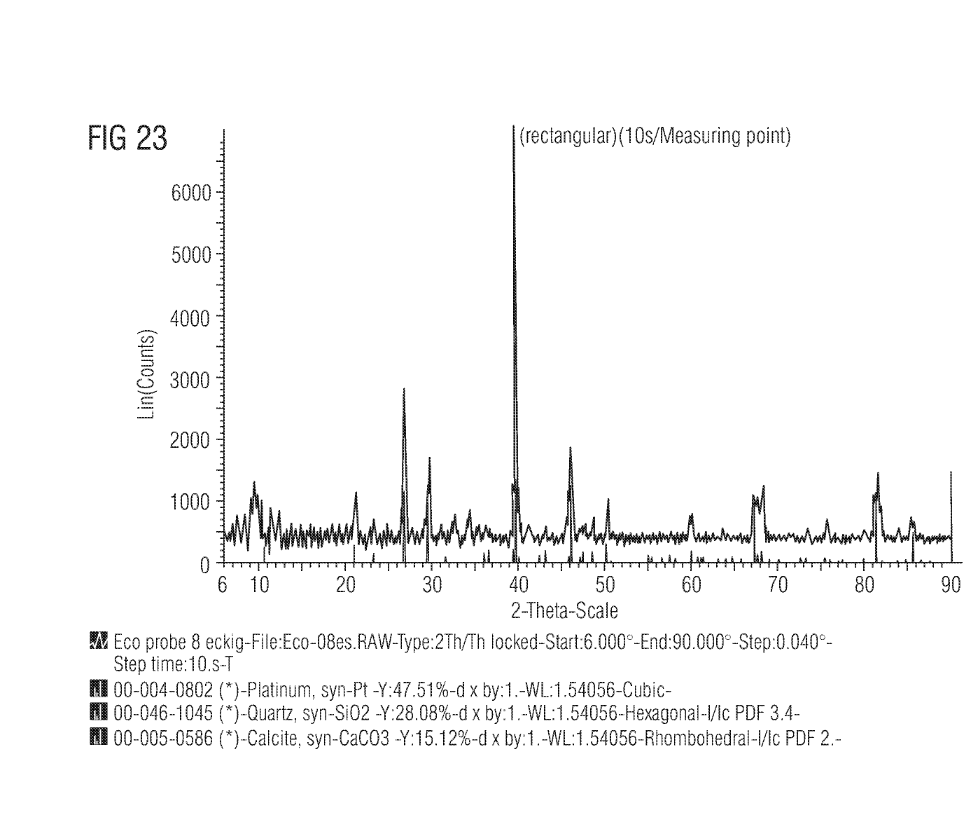

FIG. 23 shows a powder diffractogram of an eleventh mixed product according to invention, which is obtained from the eleventh mixed starting material.

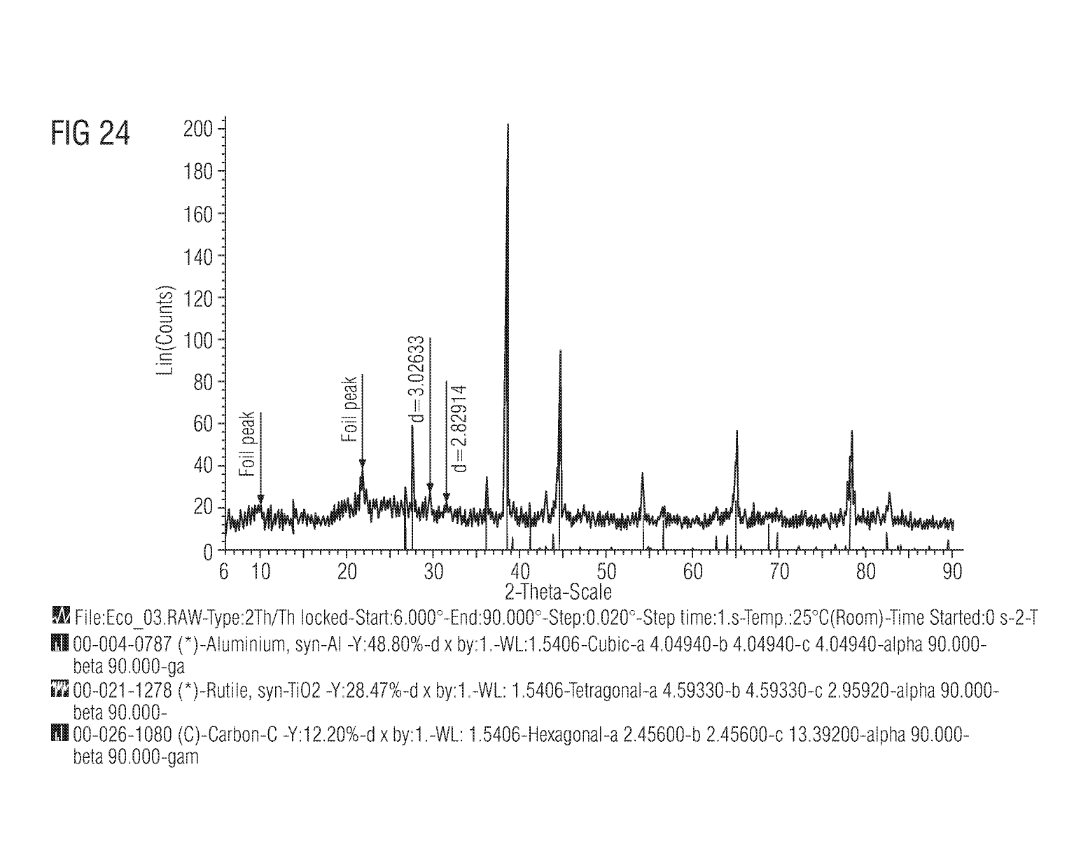

FIG. 24 shows a powder diffractogram of a twelfth mixed starting material.

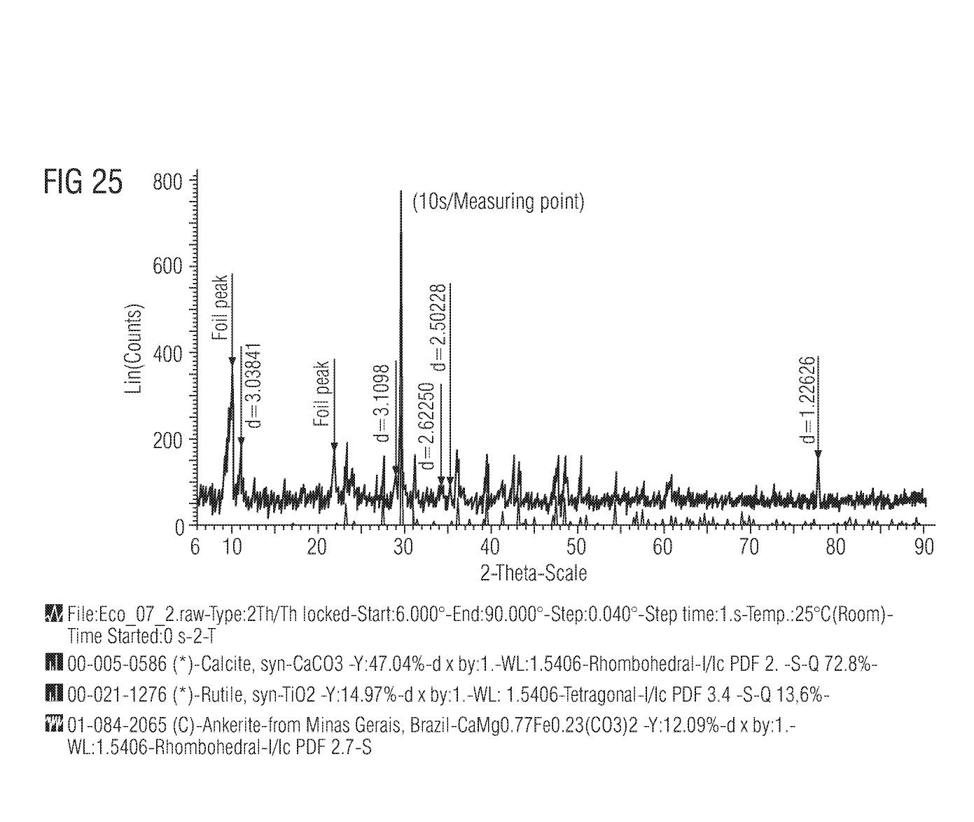

FIG. 25 shows a powder diffractogram of a twelfth mixed product according to invention, which is obtained from the twelfth mixed starting material.

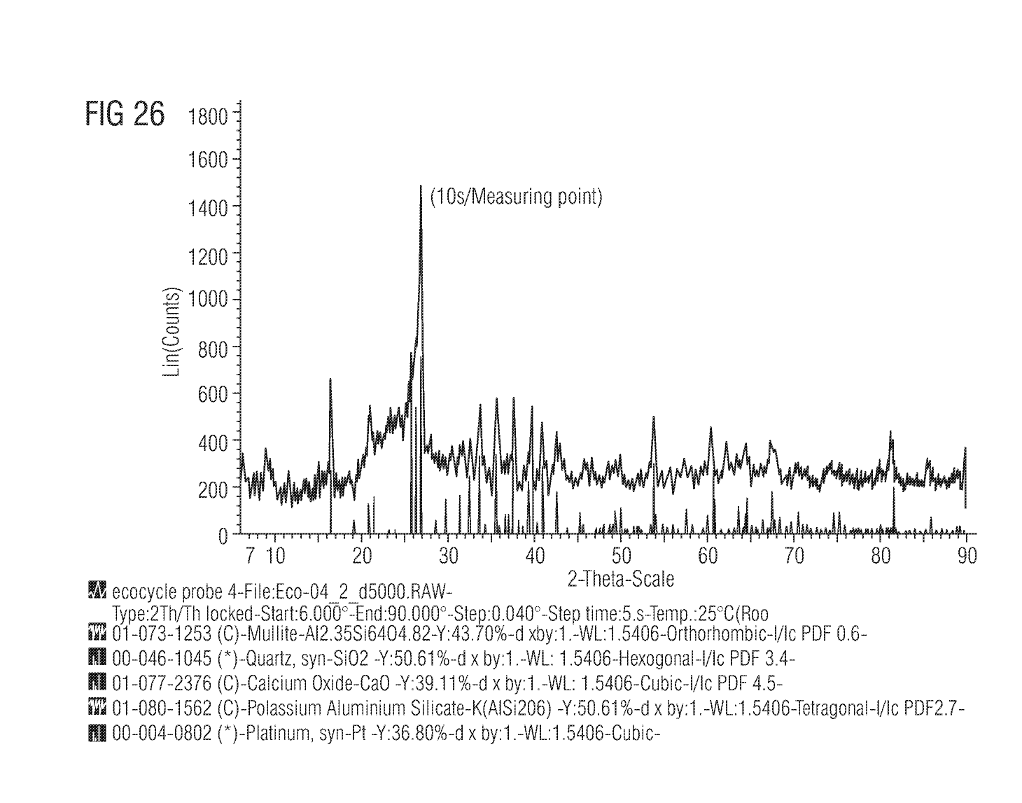

FIG. 26 shows a powder diffractogram of a thirteenth mixed starting material.

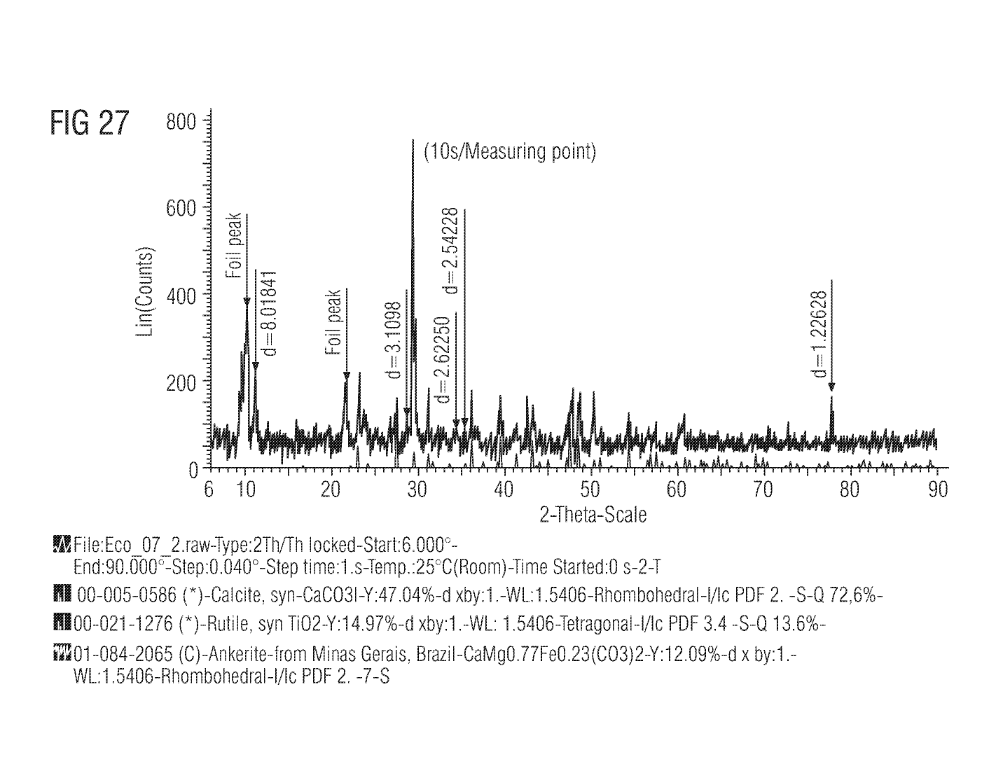

FIG. 27 shows a powder diffractogram of a thirteenth mixed product according to invention, which is obtained from the thirteenth mixed starting material.

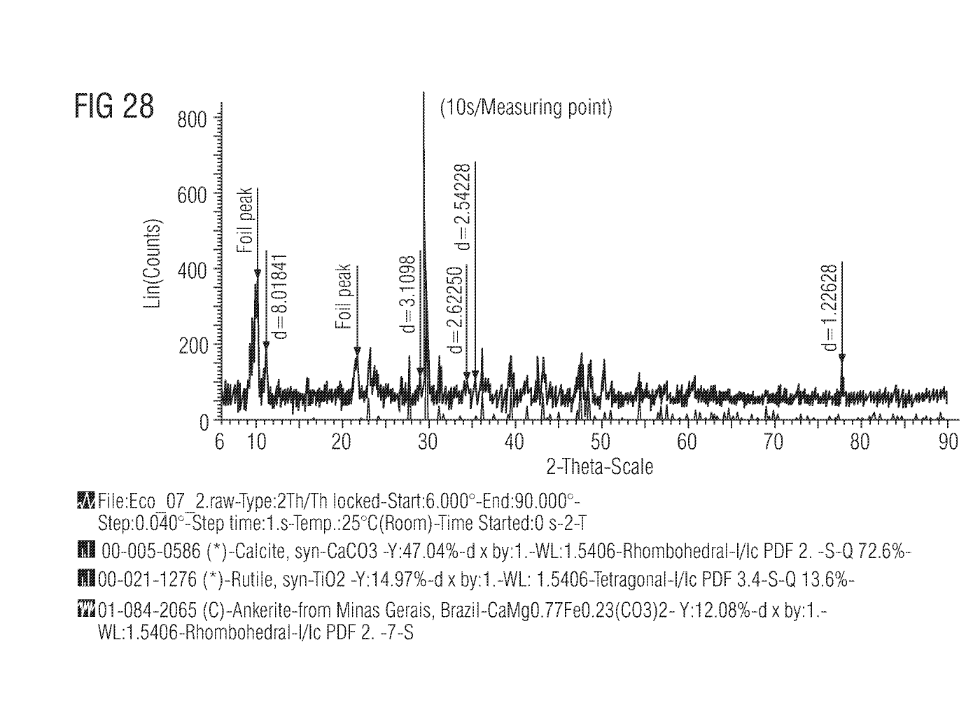

FIG. 28 shows a powder diffractogram of a fourteenth mixed starting material

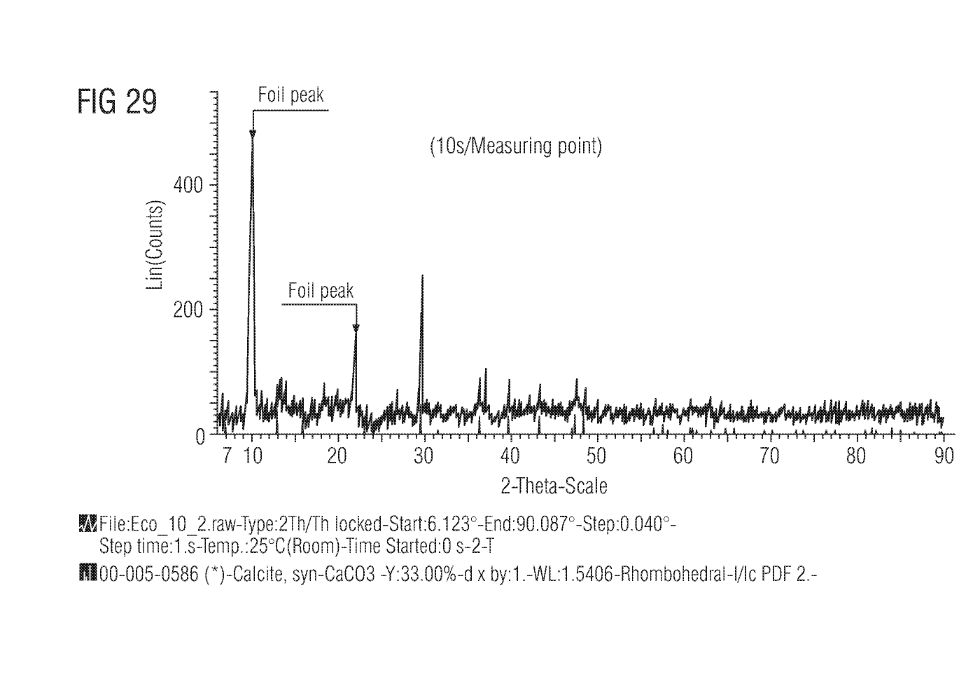

FIG. 29 shows a powder diffractogram of a fourteenth mixed product according to invention, which is obtained from the fourtheenth mixed starting material

### DETAILED DESCRIPTION OF THE INVENTION

The following exemplary description of a method for the manufacture of a mixed product according to invention is explained with reference to FIG. 1, in which a flow diagram of an exemplary operational sequence is given for the manufacture of a mixed product. All of the following percentage figures are, if not differently indicated, percentage by weight.

The raw materials to be processed are analyzed before the introduction into the manufacture, by a method specified below. Data is received from this analysis. The received data of this analysis are input into a process computer. The process computer uses the received data for the creation of a suitable recipe. This recipe can be easily determined from the measured composition of the raw materials taking the above points into account. Of course it is possible to carry out this determination using a computer program, as the determination substantially corresponds to the solution of a system of linear equations.

The input values for the starting materials, e.g. sludge, paper sludge, plastic materials, wood, composites, made of plastic and wood, products of the mechanical-biological residual treatment, bone meal, oil remainders, hydrocarbon and hydrocarbon residual substance products, e.g. roofing felt, tar covers and/or organic residual substance products, as gravel-wash dredges e.g. sediment materials, reservoir sediments, side materials or power station fly ash, are different. In a preparatory step, it is ensured that the maximum particle size of the single components is 300 mm is achieved by means of a shredder 1. The cut up parts of the starting materials are conveyed substantially by means of conveyor 2 to a first processor (K1) 3, whereby metals are separated by separators. A separation of the metals also takes place within the first processor (K1) by means of centrifugal force. The weight of the conveyed material is measured automatically with a belt weigher ‘(not shown). The received data are then also entered into the process computer. In the first processor (K1) 3 the starting materials are further reduced in size to a size of smaller than or equal to 3 mm This repeated reduction in size takes place, for example, via rotation apparatus (not shown) which can have a high rotation speed of up to 2800 U/Min over a length of up to 1300 mm A further separation takes place later within the second processor (K2) by means of centrifugal force and additionally by means of a metal separator. During this repeated size reduction process a large amount of energy is added to the starting materials which leads to an evaporation of the water content. Up to 90% of the water content evaporates. The arrangement of the rotation apparatus is aligned in such a way, such that up to 90% of the starting materials have a size that does not exceed 1 mm

After treatment of the starting materials in the first processor (K1) 3, the prepared raw material is analyzed. Different measurements are carried out. In particular the following data is measured:
the grinding fineness (this corresponds to up to 98% of particles with a size under 3 mm)
the distribution index (here it is measured which portions of the prepared raw material have a size of under 3 mm and/or 1 mm)
the weight
the humidity
the pH value
the elementary composition of the prepared raw material (this is done continually by x-ray analysis (RFA), in particular the content of carbon is determined).

The measured data is measured by means of measuring points along the conveyor and input into the process computer and compared with the values of the recipes given below. This analysis leads to the sending of appropriate control instructions to the mixing and dosing program which is upstream of a second processor (K2) 7. In the second processor (K2) 7, the second process stage takes place. The input of the materials corresponding to the recipes takes place in the dosage unit of the second processor (K2) 7.

A counting wheel lock or a similar technical device is arranged as the dosage unit. The dosage is based on the recipe which is automatically selected by the computer mentioned above.

In the second processor (K2) 7 the individual components of a first material mixture are multiply reduced to a size smaller than or equal to 50 μm. The portion of materials having a fine grain of 3 mm, i e a diameter over 3 mm is about 5%, and the proportion of materials with a 1 mm fine grain is about 8%. The remainder is fine grain with a diameter of under 1 mm The main component has a size of less than 100 μm. This fine particle size distribution relationship is relevant for the stabilization of the mixture.

The first material mixture is passed to the conveyor 17 after the treatment in the second processor (K2) 7.

The same measurements as described above take place. Further remaining metals from the first material mixture are separated such that no metal is further found to a degree of 99%.

The input of the material mixture 21 into the third processor (G1) is followed. This is done by means of the conveyor 17. As can be seen the first material mixture can be conveyed by a further dosage unit.

A first intensive mixing takes place in the third processor (G1) 21. Further additives are added to the first material mixture according to the recipe. The portion of the first material mixture amounts to about 85%. Thus about 15% of additives are added. The first material mixture is brought back on to a conveyor 25 (or similar conveyer system).

A check measurement takes place by means of inserted sensors in the area of the conveyor 25. The same measurements are carried out as described above. The mixed product is then forwarded by conveyor 25 to a fourth processor (G2) 34. A subsequent adjustment of the composition takes place via the addition of further additives. Usually a second material mixture is created which consists of 0 to 5% of the newly added additive and to 95 to 100% of the first material mixture. The transport takes place by means of a fourth dosage unit at the fourth processor (G2) 34.

The second material mixture is brought again on to a conveyor and passed for treatment. The passage to treatment can take place via a pellet-making device and a drum filter. The mixed product is created according to the invention.

Subsequently a pre-defined quality control takes place. The same measurements as made above are carried out and furthermore the pellets are sorted. Once the quality standard of at least 99% is reached the product is passed to the storage 38.

If the predefined quality standard is not reached, i.e. if less than 99% of the product corresponds to the desired composition, the second material mixture is passed to a “reject chute”. From there the rejected second mixture is supplied to the process again in a proportion of less than 10% “reject material” to more than 90% new materials. The new mixture is subsequently regarded as starting material when it comes to the calculation of the additives. A reason for the non fulfilment of the predefined quality control standard is that the mixing ratio of 75 to 85% of organic components and thus 25 to 15% of inorganic components in the starting material and/or starting materials is not present. If this mixing ratio of the starting materials is not present, the desired crystal structure can not be sufficiently formed.

An advantage of the mixed product according to the invention resides in that cheap secondary raw materials can be used for its manufacture. The mixed product according to the invention is a starting product for further end products. The end product has residual materials as its starting point, so that in a use an ecological balance is attainable.

In addition it is desired to use inorganic bonding agents predominantly manufactured from residual materials as inorganic materials. Thus the undesirable use is avoided of conventional inorganic materials like inorganic bonding agents made using a lot of energy and from relatively expensive raw materials and may cause substantial damage to the natural landscape.

Further aspects of the invention are to be found in the dependent claims and the following description.

It should be noted that the recipe of the mixed product is adapted to the desired end products. This recipe governs the choice of the appropriate residual substances and/or residual substance mixtures and also the additives which are added for the formation of the mixed product. Thus the material properties of the mixed product having a material specification are tuneable. Likewise by adding additives, the properties of the mixed products in each of its various forms are tuneable according to use.

The mixed product according to invention is according to its composition the starting material for further subsequent products and subsequent applications. The mixed product can also be in addition itself a final product. The mixed product can be used, for example, as exhaust and particle filters to remove CO₂ at low temperatures and also further pollutants from exhaust gases, for example industrial pollution gases. Certain pollutants can be removed even at higher temperatures. However this application is only beneficial to the ecological balance if the further processing of the loaded material does not lead to a repeated release of the CO₂. A drying process of the mixed product occurs at the same time with the employment as a CO₂ filter in the low temperature range, as well as a reduction of the pH value.

The mixed product is suitable also as an aggregate in the building materials industry e.g. as a filler for concrete products in ditch, channel and road construction, as well as a filler for noise control and embankment construction elements.

Further a use is possible in the metal processing, wood treatment and paper treatment industries.

The treated mixed product is also used for drinking water processing. A reduction of the bacteriological content and heavy metal content can be obtained by using iron compounds.

A further use of the mixed product is as an effective reduction compound and immobilization means for chrome VI containing wastes. A reduction of chrome VI takes place to chrome III. Chrome VI is regarded as one hundred to one thousand fold more toxic than chrome III and is much more mobile than chrome III.

For this application the mixed product is conditioned with ground clay and a small quantity of H₂SO₄ (pH value approx. 3) as additives. This mixed product is an effective reducing agent for chrome VI. After the reduction of chrome VI to chrome III in a weakly acidic environment, buffering to a neutral value and heavy metal stabilization is achieved by addition of ground limestone (with a grain size less than 200 μm).

The mixed product in baked form is a ceramic material with large specific surface which is usable together with the starting mixed product for the production of an oil binder. An oil binder e.g. for use in water is prepared from a combination of the starting mixed product and from mixed products that have certain components baked at low temperatures and certain components baked at high temperatures. The oil binder is dried in air, ground and/or pelleted.

The mixed product is also used in the tyre industry and leads to the reduction of the rubber-specific lubrication behaviour so that a reduction in a braking distance and a higher life span is achieved. The mixed product is used in animal husbandry as animal litter, agriculture, horticulture and landscape gardening for the improvement of the soil properties with respect to water retention and fertilization.

The following materials can be used as residual substances in the mixed product of the invention: sludge, paper pulp sludge, plastic materials, wood, composite materials from plastic and wood, products of mechanical-biological waste treatment, bone meal, oil remainders, hydrocarbon and hydrocarbon waste derivative products, e.g. roofing felt, tar covers, residual substances with substantial organic and/or inorganic residual substances, such as gravel-wash dredge e.g. sediment materials, reservoir sediments, or side materials, power station fly ash or other ashes.

A treatment of “pasty” residual substances (e.g. oil mud) takes place in each case according to the logistical situation. The treatment is either directly for the production of a processable organic rich components for later mixture with mineral additives or is the treatment with a selection of mineral additives and the baked mixed product followed by grinding to a grain size of less than 200 μm. The subsequently in a mixed formed pumpable substance is led into an activator via a sieve feeder. A homogenising and mechanical disaggregation is achieved by adding additives such as quicklime, clay flour and starting mixed product

The prepared residual substances are added with residual substances not requiring further treatment. Subsequently a measured addition of these added residual substance components with mineral additives takes place using a mixture of mineral additives. The mixture of mineral additives is adapted to the product chain and the product application. A required organic-mineral additive (ground clay with lignin derivatives) is added.

The most important components of the mineral additives and/or additive mixture of the mixed product are:
1. powdered minerals from clay and/or clay rock or marl and/or marl rock—ground to less than 200 μm by dry grounding and/or wet grinding to less than 50 μm.
2. Powdered mineral from limestone—ground to less than 200 μm and/or by wet grounding to less than 50 μm.
3. Ca(OH)₂, preferably as powdery white calcium hydrate with 69-75% CaO, 0.2-2.5% MgO, bulk density=0.2-0.3 kg/dm³.
4. Power station fly ash or other ashes.
5. Bentonite and/or zeolite (klinoptilolite), both mineral materials exhibit a high cation exchange capacity; bentonite having a damp, sealing, expandable, micropore increasing ability; zeolite being structurally stable with high smell-reducing characteristics.
6. Organic-mineral additive: Mineral carrier material with lignin derivatives.

Important tasks of the organic rich residual components, including liquid, “pasty” and solid hydrocarbon residual substance products in the mixed product are:
1. Energy carrier/material for energy conversion and/or
2. Porous inducing means and/or
3. Structuring means and/or
4. Reducing agent and/or
5. Filtering material.

Main tasks of the mineral additives in the mixed product are:
1. Mechanical stabilization of the output mixed product and the subsequent products, e.g. mixing product in baked form; Oil binder as well as microstructuring.
2. hygienization (pH 12 by addition of Ca(OH)₂).
3. Optimization of the ceramic and cement properties.
4. Pollutant immobilization (stability against elution, e.g. heavy metals, ammonium).

Manufacturing process for the mixed product as a function of residuals and the use-specific additives including pre-treatment of residual substances and inorganic additives
a) Residual substance pre-treatment, whereby according to the kind of residual substance the following steps can be dispensed with:
   1. Rough segregating of metal components.
   2. Reduction of size depending upon material type to less than 300 mm and up to 30 mm
   3. Magnetic separation of iron containing metal components.
   4. Subsequent reduction of size to less than 8 mm
   5. Further magnetic separation of iron containing metal components.
   6. Further size reduction to grain size of the inorganic additives before and/or during the mixing process.
b) Pre-treatment and properties of the predominant inorganic components (mineral additives) of the mixed product:
   1. Powdered mineral from clay and/or clay rock or marl and/or marl rock by dry grinding with ground drying process to less than 200 μm. The clay/clay rock consists predominantly of clay minerals (fine-grained layer silicates e.g. kaolin, montmorillonite, bentonite) as well as further minerals, e.g. quartz, feldspar, oxides and/or hydroxides, e.g. Fe, alkali, alkaline-earth, and possibly small quantities of carbonate minerals. In individual cases the minerals can be carbonate-free. Marl/Marl rock is usually clay containing silica/carbonates which contain carbonate minerals (here substantially calcite) beside the minerals specified above in a proportionally similar order of magnitude.
   2. Powdered mineral from limestone of less than 200 μm. For certain applications it is important that substantially only calcite is present as a carbonate mineral. Slight impurities by silicate or other non carbonate mineral is irrelevant.
   3. Ca(OH)₂: white calcium hydride powder, with 69-75% CaO, 0.2-2.5% MgO, bulk density 0.2-0.3 kg/dm³, technically water-free and carbonate-free, fine powder according to Euro standard 459-2.
   4. Power station fly ash, alkali-rich (fluxing agent for special product profiles), fineness of grain according to current Euro standard of the concrete technology.
   5. Bentonite with minimum content of smektite of 60% (lean bentonite) with corresponding cation exchange capacity (compared with other clay like materials), fine-grained, i.e. dry ground with dry grounding to less than 200 μm, technically detention-water-free (dampness less than 1%) and carbonate-free.
   6. Zeolite, klinoptilolite (natural zeolite), klinoptilolite content more than 60% with appropriate mineralogical-chemical and environmental technical properties such as ion exchange capacity (pollutant binding, nutrient storage), smell binding and water storage; untreated, fine-grained: dry ground with grinding to less than 200 μm technically detention-water-free and carbonate-free.
   7. Mineral carrier material with lignin derivatives and/or lignin fission products (additives of organic-mineral nature), dry grinding to less than 200 μm, dampness of less than 1%, with fine grain (less than 200 μm) bentonite and/or other mineral carrier material intimately blended, content of lignin derivatives or lignin fission products larger than 70%.
c) Manufacturing process of the mixed product:
   1. Pre-treatment of the residual substance and additive components as defined under a) and b).
   2. Mixing procedures: Addition and combination of all residual substance components via dosage units and one or more downstream mixing units. In individual cases the mixing unit is arranged as a cutting up unit (“activator”).
   3. Humidity adjustment: Procedure selection and moisture content depending upon residual substance and additive components; Moisture content determined according to DIN (e.g. combination of DIN 18,121 T1, furnace drying process/basic method and DIN 18,121 T2, quick method) of 10-45 weight %.
   4. Grain size adjustment of the mixed product aggregates: By means of sieving and feedback of the over sized granules. Conclusion of the manufacture of the starting mixed product.
   5. Drying process for the production of mixed product:
      a) As a low temperature-CO₂-Filter (approx. 100° C.), with simultaneous particle filter function, by using the exhaust gas from the smoke gas filtering;
      b) Conventional drying procedures using added energy. Finalising the manufacture of the mixed product “drying”.

The recipes for the mixed product are selected as a function of the intended use and/or on the intended subsequent product:
a) The mixed product as exhaust filters (CO₂-absorbtion and particle filtering) in the low temperature range; Use of mixed product “drying” as a cold aggregate for the building material industry, e.g. filler for concrete products in landscape, ditch and road construction as well as a filler for noise control elements and embankment construction elements
   1. Kind of residual substance: In principle all organic residual substances and products, including plastics and hydrocarbon and hydrocarbon derivatives residual substances and products; non-organic non-metallic residual substances, products and sediment materials, e.g. gravel-wash dredge and reservoir sediments, also as additive supporters or additive replacement filler and/or supporting granules.
   2. Residual substance quantity (organic): Depending upon residue material, function and product profile 30-80 weight % (related to dry substance according to current Euro standard).
   3. Residual substance quantity (inorganic): Depending upon residual material, function and product profile 0-45 weight % (related to dry substance according to current euro standard).
   4. Mineral additives: Depending upon function and product profile 3-40 weight % (related to dry substance according to current Euro standard).
   5. Additives of organic-mineral nature: Depending upon function and product profile 0-18 weight % (related to dry substance according to current Euro standard).
b) Dried mixed product, mixed product “drying” as starting material for the production of burned (ceramic) mixed product:
   1. Kind of residual substances (organic): All listed a) 1 organic residual substances.
   2. Kind of residual substances (inorganic): Fine-grained sediment materials as specified under 3.1, wet in natural condition and/or ground (less than 200 μm). Coarse-grained remaining materials (e.g. demolition materials) as economically favourable supporting granules and/or fillers for special applications.
   3. Residual substance quantity (organic): Depending upon the type of residual material, function and product profile 30-80 weight % (related to dry substance according to the current Euro standard).
   4. Residual substance quantity (inorganic): Depending upon the type of residual material, function and product profile 0-45 weight % (related to dry substance according to current Euro standard).
   5. Mineral additives: Depending upon function and product profile 3-40 weight % (related to dry substance according to current Euro standard).
   6. Additives of organic-mineral nature: Depending upon function and product profile 0-18 weight % (related to dry substance according to current Euro standard).
c) Mixed product “drying” in mixture with baked mixed product for the production of oil binder for use on land:
   1. Used type of mixed product: Mixed product “drying”, made of:
   i) organic containing residual substances as mentioned under a) 1,
   ii) in the natural condition fine-grained residual substances as mentioned under a) 1,
   iii) mineral additives, as mentioned under b) pre-treatment and properties of the predominant inorganic components as mentioned under b) 1-6, and
   iv) organic-mineral additives, as under b) pre-treatment and properties of the predominantly inorganic components 7.
   2. Used baked type of mixed product: Made of mixed product “dry” according to recipe b) 1.-6.
   3. Mixing proportion of mixed product “dry” and mix product “baked”: 6:1 to 1:6.
   4. Method of manufacture of oil binders for rural use:
   i) size reduction of the mixed product baked; after baking the pre-broken material is further reduced in size and is optionally ground for the production of fine factions and subsequently an application-specific mixing of chosen grain size ranges.
   ii) “dry” mixing of mixed product “dry” and mixed product “baked” according to a selected granular size by means of conventional mixing methods, for example a forced mixer or a flow mixer (optionally an activator)
   iii) in individual cases common grinding of mixed product “baked” and mixed product “dry”.
d) mixed product “dry” in the mixture with mixed product “baked” and the broken mixed product “baked” for the production of oil binder for use on water:
   i) Used type of mixed product: as mentioned under c) 1. (mixed product “dry”)
   ii) used burned mixed product type as mentioned under c) 2;
   iii) used baked, broken type of mixing product: as described in the following for the manufactures of mixed product “baked”
   iv) mixing proportion mixed product “dry”:Mix product “baked”:broken mixing product “baked”: Each component 10-60 weight % dry weight (according to current Euro standard)
   v) manufacturing process of the oil binder for the use on water
   vi) dosage: according to the application conditions by means of conventional dosing equipment
   vii) mixing: drying mixture as given in c) 2
   viii) hydrophobic treatment: by means of proportioned spraying of the total product with carbohydrate

Manufacturing process of mixed product “baked” from mixed product “dry” for the manufacture of oil binders for the use on land
a) Humidity adjustment and manufacture of a substance capable of extrusion from the mixed product “dry”, This is technically similar to conventional brick technology
b) Manufacture of baked forms: Mixture in double wave mixers or similar mixing devices and pressing out by means of extrusion press or similar devices under use of a cutter
c) Baking: baked in a tunnel furnace or other suitable baking device in the temperature range of 750°-950° C. (without baking effect and mostly without CO₂ emission)
d) cutting up: pre braking after the initial baking

Manufacturing process of baked, broken mixed product from the starting mixed product, mixed product “dry” and/or mixed product “baked” as well as recipes for the manufacture of oil binders for use on water:
a) Mixed product “dry”: Manufacture according to c) Manufacturing for the mixed product according to 5, and above for the production of oil binders for use on land according to 1.
b) Manufacture of broken, baked mixed product: as above for the manufacture of oil binders for use on land as indicated however baking at the higher temperature range
c) cutting up: by means of conventional crushers with feedback of over-sized grain
d) hydrophobic treatment: By means of closed spraying of the broken product by hydrocarbones

To aid in the understanding of the mixed product according to the invention and the method for manufacturing of the mixed product some powder diffractograms are attacked. A sample before the treatment and a sample after treatment were analyzed in each case in order to demonstrate the chemical conversions as described above. The results of measurement of the powder diffractrometry are attached as diagrams.

The following starting materials result in the case of the mixed product according to invention:

| Starting material: | Mixed-Product: |
|---|---|
| FIG. 2 | FIG. 3 |
| FIG. 4 | FIG. 5 |
| FIG. 6 | FIG. 7 |
| FIG. 8 | FIG. 9 |
| FIG. 10 | FIG. 11 |
| FIG. 12 | FIG. 13 |
| FIG. 14 | FIG. 15 |
| FIG. 16 | FIG. 17 |
| FIG. 18 | FIG. 19 |
| FIG. 20 | FIG. 21 |
| FIG. 22 | FIG. 23 |
| FIG. 24 | FIG. 25 |
| FIG. 26 | FIG. 27 |
| FIG. 28 | FIG. 29 |

1-18. (canceled)

19. A mixed product of organic and inorganic particulate materials, wherein the organic and inorganic particulate materials together form a homogeneous matrix, wherein 75 to 85 dry weight % of organic and inorganic particulate materials are materials substantially free of metal, and wherein the remainder comprises additive materials, wherein further 80 to 90 dry weight % of the additive materials comprises at least one of clay, zeolite and lime, and wherein the rest of the remainder is at least one of lignin or lignin derivatives, and wherein a particle size of the organic and inorganic particle materials forming the matrix is between 50 μm and 3 mm.

20. The mixed product according to claim 1, wherein the substantially metal free materials comprise 82% weight of the organic and inorganic particulate materials.

21. The mixed product according to claim 1, wherein the clay comprises bentonite.

22. The mixed product according to claim 1, wherein the mixed product is a solid phase.

23. The mixed product according to claim 1, wherein the mixed product is granular.

24. The mixed product according to claim 1, wherein the mixed product is of a fibrous form.

25. The mixed product according to claim 1, wherein the mixed product is of a paste like form.

26. The mixed product according to claim 1, having a moisture content of between 10% and 45% weight, with respect to the dry content.

27. The mixed product according to claim 1, having at least one of air-dried form, baked form or ceramisised form.

28. The mixed product according to claim 1, wherein the organic ones of the organic and inorganic particulate materials is at least one of sewage sludge, paper pulp, plastic material, wood, composites of plastic and wood, products of mechanical-biological residual substance treatment, bone meal, oil remainders, hydrocarbon and hydrocarbon residual substance products, tar covers and an inorganic residual substance product, comprising at least one of sediment materials such as gravel wash dredges, reservoir sediments or side materials, power station fly ash or other ashes.

29. The mixed product according to claim 10, wherein the hydrocarbon residual substance product is roofing felt.

30. The mixed product according to claim 1, wherein the inorganic ones of the organic and inorganic particulate materials comprise powdered minerals, comprising at least one of clay minerals or marl minerals or limestone.

31. The mixed product according to claim 12, wherein a particulate size of the limestone is less than 200 μm.

32. The mixed product according to claim 1, wherein the inorganic ones of the organic and inorganic particulate materials comprise pulverised white calcium hydrate with 69%-75% CaO and 0.2%-2.5% MgO with a bulk density of 0.1-0.3 kg/dm³.

33. The mixed product according to claim 1, wherein the inorganic ones of the organic and inorganic particulate materials comprises bentonite.

34. The mixed product according to claim 15, wherein the bentonite is lean bentonite, with a minimum content of 60% smektite.

35. The mixed product according to claim 16, wherein the lean bentonite has a minimum content of 60% smektite.

36. The mixed product according to claim 1, wherein the inorganic ones of the organic and inorganic particulate materials comprises zeolite.

37. The mixed product according to claim 15, wherein the zeolite is klinoptilolite, with a particle size of less than 200 μm.

38. The mixed product according to claim 1, wherein a mineral support material of organic-mineral nature is at least one of bentonite or a mineral carrier material mixture with lignin derivatives or lignin fission products and is blended with the support material or the carrier material mixture.

39. The mixed product according to claim 20, wherein a content of lignin derivatives or lignin fission products is at least 70% lignin.

40. The mixed product according to claim 1, wherein an organic one of the
organic and inorganic particulate materials comprises a quantity of 30%-80% dry weight.

41. The mixed product according to claim 1, whereby the inorganic ones of the organic and inorganic particulate materials comprises a quantity of 0%-45% dry weight.

42. The mixed product according to claim 1, whereby the inorganic ones of the organic and inorganic particulate materials 3%-40% dry weight.

43. The mixed product according to claim 1, whereby the additives materials comprise organic-mineral materials in a quantity of 0%-18% dry weight.

44. The mixed product according to claim 1, comprising a hydrophobising treatment material.

45. The mixed product according to claim 1, whereby the lignin derivatives are selected from the group consisting of calcium-ligninsulfonate, natrium-ligninsulfonate, ammonium-ligninsulfonate and magnesium-ligninsulfonate.
